(19) United States
(12) Patent Application Publication
(10) Pub. No.: US 2023/0075250 A1
(43) Pub. Date: Mar. 9, 2023

(54) OPTICAL FIBER AND LASER PROCESSING MACHINE

(71) Applicant: AMADA CO., LTD., Kanagawa (JP)

(72) Inventors: Ryouhei ITO, Kanagawa (JP); Hiroaki ISHIGURO, Kanagawa (JP); Masatoshi TANAKA, Amagasaki-shi, Hyogo (JP); Tomohiko ISHIDA, Amagasaki-shi, Hyogo (JP); Seongjin KIM, Tokyo (JP)

(21) Appl. No.: 17/801,512

(22) PCT Filed: Feb. 24, 2021
(86) PCT No.: PCT/JP2021/006776

§ 371 Date: Aug. 22, 2022

(30) Foreign Application Priority Data
Feb. 26, 2020 (JP) 2020-030597

(51) Int. Cl. B23K 26/064; G02B 6/02

(52) U.S. Cl. CPC B23K 26/064; G02B 6/02

(57) ABSTRACT

A process fiber including a core extending along a central axis and a clad covering a circumference of the core includes an outer edge portion constituting an outer edge of a core cross section obtained by vertically cutting the core. The outer edge portion includes seven sides and seven corner portions respectively connecting the sides adjacent to each other. Each of the corner portions has an R shape along a circumscribed circle circumscribed to the outer edge portion. When a diameter of the circumscribed circle is O, a diameter of an inscribed circle inscribed to the outer edge portion is I, and the number of the corner portions is n (n is an odd number), a diameter ratio α, which is a ratio between the diameter O of the circumscribed circle and the diameter I of the inscribed circle, fulfills a predetermined condition.

### TECHNICAL FIELD

The present invention relates to an optical fiber and a laser processing machine.

### BACKGROUND ART

A laser processing machine is known that performs laser processing such as laser welding by irradiating a workpiece with a laser beam from a laser processing head of a main body of the laser processing machine. The laser processing machine is provided with a laser oscillator, and the laser beam output from the laser oscillator is transmitted to the laser processing head by a process fiber.

Patent Literature 1 discloses an optical fiber device including an optical fiber for transmitting a laser beam. Patent Literature 1 discloses an optical fiber in which a core cross-section thereof is formed in a non-circular shape.

### CITATION LIST

### Patent Literature

Patent Literature 1: Japanese Patent Application Laid-Open Publication No. 2015-143755

### SUMMARY

However, when mode mixing in the optical fiber is not sufficient, the intensity distribution may not be uniform.

One aspect of the present invention provides an optical fiber and a laser processing machine capable of promoting mode mixing and thus making intensity distribution of a beam profile uniform.

One aspect of the present invention is an optical fiber including a core extending along a central axis and a clad covering a circumference of the core, the optical fiber including an outer edge portion constituting an outer edge of a core cross section obtained by vertically cutting the core with respect to the central axis of the core. The outer edge portion includes a plurality of sides and a plurality of corner portions respectively connecting the sides adjacent to each other so that the plurality of sides are continuous, and at least one corner portion of the plurality of corner portions has an R shape along a circumscribed circle circumscribed to the outer edge portion. When a diameter of the circumscribed circle is O, a diameter of an inscribed circle inscribed to the outer edge portion is I, and the number of the plurality of corner portions is n (n=an odd number), a diameter ratio α (α=O/I), which is a ratio between the diameter O of the circumscribed circle and the diameter I of the inscribed circle, satisfies a predetermined conditional expression (the mathematical formula 11).

According to the one aspect of the present invention, it is possible to promote the mode mixing and make the intensity distribution of the beam profile uniform.

### BRIEF DESCRIPTION OF DRAWINGS

FIG. 1 is a diagram schematically showing an overall configuration of a laser welding machine according to a first embodiment.

FIG. 2 is a diagram illustrating a configuration of an optical fiber according to the first embodiment.

FIG. 3 is a diagram illustrating an AA cross section of a core shown in FIG. 2.

FIG. 4 is a diagram showing a normal vector in a circular core.

FIG. 5 is a diagram showing a normal vector in a hexagonal core.

FIG. 6 is a diagram showing a normal vector in a heptagonal core.

FIG. 7 is a diagram showing a normal vector in a heptagonal core in which an R shape is provided at a corner portion thereof.

FIG. 8 is a diagram showing the relationship between an outer edge portion of the heptagonal core, and a circumscribed circle circumscribed to the outer edge portion and an inscribed circle inscribed to the outer edge portion.

FIG. 9 is a diagram showing a beam profile with respect to the ratio between the circumscribed circle and the inscribed circle.

FIG. 10 is a diagram illustrating a parameter for defining the R shape of the corner portion.

FIG. 11 is a diagram showing a modified example of the heptagonal core.

FIG. 12 is a diagram illustrating a configuration of an optical fiber according to a second embodiment.

FIG. 13 is a diagram illustrating an AA cross section of a heptagonal core shown in FIG. 12.

FIG. 14 is a diagram illustrating a BB cross section of the heptagonal core shown in FIG. 12.

### DESCRIPTION OF EMBODIMENTS

### First Embodiment

An optical fiber and a laser processing machine according to the present embodiment will be described with reference to the drawings. Hereinafter, as the laser processing machine, a laser welding machine that welds a workpiece with a laser beam will be exemplified, but the laser processing machine may be a laser cutting machine that cuts a workpiece with a laser beam.

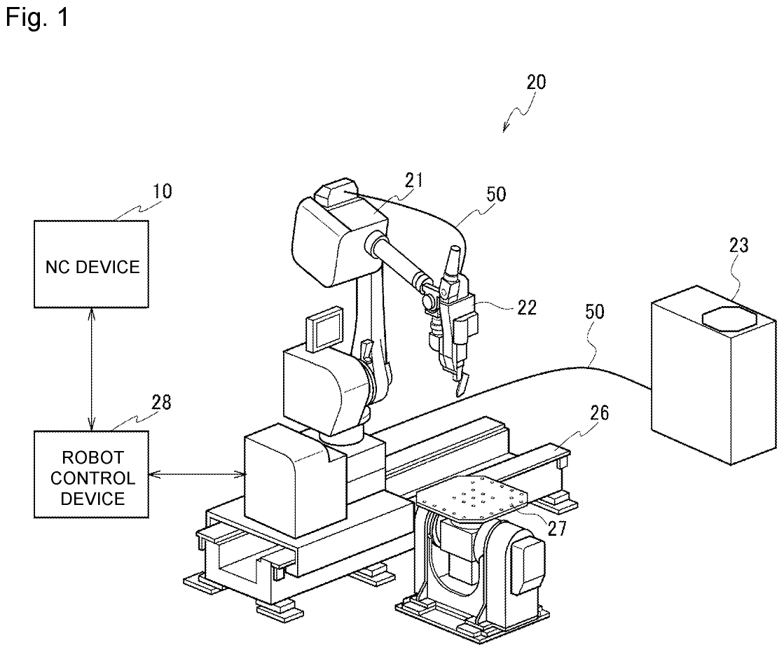

FIG. 1 is a diagram schematically showing an overall configuration of the laser welding machine according to the first embodiment. The overall configuration of a laser welding machine 1 will be described with reference to FIG. 1. The laser welding machine 1 is mainly composed of an NC device 10 and a welding robot 20.

The NC device 10 is mainly composed of a computer including a CPU (Central Processing Unit), a ROM (Read Only Memory), a RAM (Random access memory), and the like. The NC device 10 realizes various functions by the CPU reading various programs from the ROM, expanding the various programs into the RAM, and executing the expanded programs.

The NC device 10 stores a processing program. Further, the NC device 10 can correct the processing program as needed. The NC device 10 transfers the processing program stored in a storage unit to the welding robot 20. The processing program is NC data (machine control codes) that executes one or more processing commands for welding a product from one welding point to another welding point.

The welding robot 20 is mainly composed of a robot main body 21, a laser oscillator 23, a process fiber 50, and a robot control device 28.

The robot main body 21 is an articulated robot. The robot main body 21 is movably supported with respect to a guide rail 26, and is configured to be able to freely travel along the guide rail 26. A surface plate 27, on which a workpiece to be welded is arranged, is installed in the vicinity of the guide rail 26.

The robot main body 21 is provided with a welding head 22 at a tip end portion thereof. The welding head 22 is connected to the laser oscillator 23 via the process fiber 50. The laser oscillator 23 is a fiber laser oscillator, a YAG laser oscillator, or the like, and oscillates a laser beam. The laser beam output from the laser oscillator 23 is introduced into the welding head 22 via the process fiber 50, and the laser beam is emitted from the tip end portion of the welding head 22 toward the workpiece.

The robot main body 21 can adjust a beam profile of the laser beam emitted from the welding head 22 to be a Gaussian type, a top hat type, a ring type, or the like, depending on a material or a thickness of the workpiece. The Gaussian type is a beam profile in which the intensity increases sharply from the peripheral portion to the central portion, and the top hat type is a beam profile in which the central portion is flat. Further, the ring type is a beam profile in which the intensity in the central portion is low and the intensity in the peripheral portion is high. In laser welding, the ring type beam profile has superiority for gap welding and the like. Examples of the method of adjusting the beam profile include a method of continuously changing the angle of the laser beam that is made incident to the process fiber 50.

The robot control device 28 controls the robot main body 21 and the laser oscillator 23 so as to weld the workpiece with the laser beam on the basis of the processing program transferred from the NC device 10.

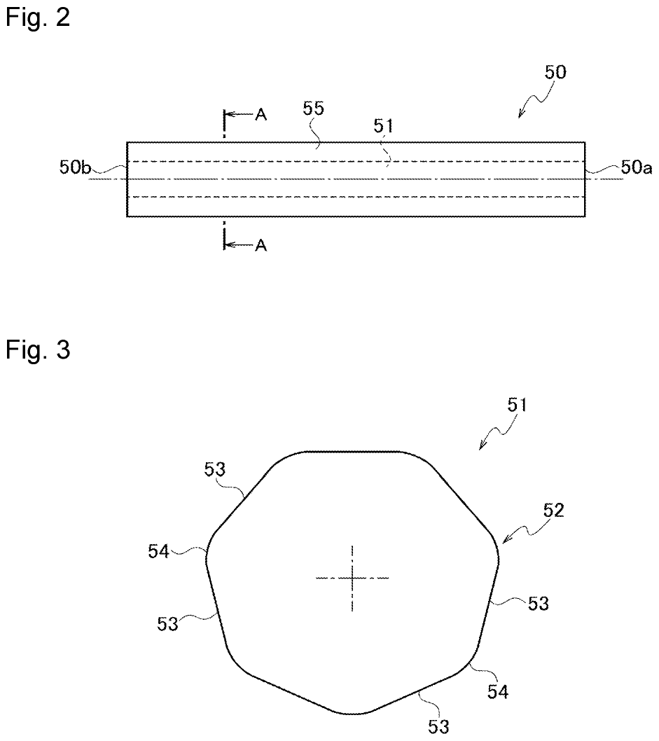

FIG. 2 is a diagram illustrating a configuration of the optical fiber according to the first embodiment. FIG. 3 is a diagram illustrating an AA cross section of a core shown in FIG. 2. The configuration of the process fiber 50 will be described with reference to FIGS. 2 and 3. The process fiber 50 is a transmission optical fiber for transmitting the laser beam. One end portion of the process fiber 50 functions as an incident end 50a of the laser beam, and the other end portion thereof functions as an emission end 50b of the laser beam.

The process fiber 50 is mainly composed of a core 51 extending along a central axis and a clad 55 covering the periphery of the core 51. The core 51 is made of a material having a higher refractive index than that of the clad 55. The laser beam made incident from the incident end 50a propagates while being totally reflected by the boundary surface between the core 51 and the clad 55, and is emitted from the emission end 50b.

As shown in FIG. 3, a core cross section obtained by vertically cutting the core 51 with respect to the central axis is a heptagon. An outer edge portion 52 that constitutes an outer edge of the core cross section is formed of seven sides 53 and seven corner portions 54. Each of the sides 53 is made of a straight line. Each of the corner portions 54 connects the sides 53 adjacent to each other so that the seven sides 53 are continuous. The core cross section of the core 51 according to the present embodiment is a regular heptagon in which the lengths of the respective sides 53 are equal and the angles of the respective corner portions 54 are equal.

An R shape, which is a curved shape having a predetermined curvature, is set at each of the corner portions 54. The R shape set at the corner portion 54 satisfies a predetermined condition. Hereinafter, prior to the description of the R shape that is to be set at the corner portion 54, the relationship between the shape of the core cross section and the intensity distribution of the beam profile will be described.

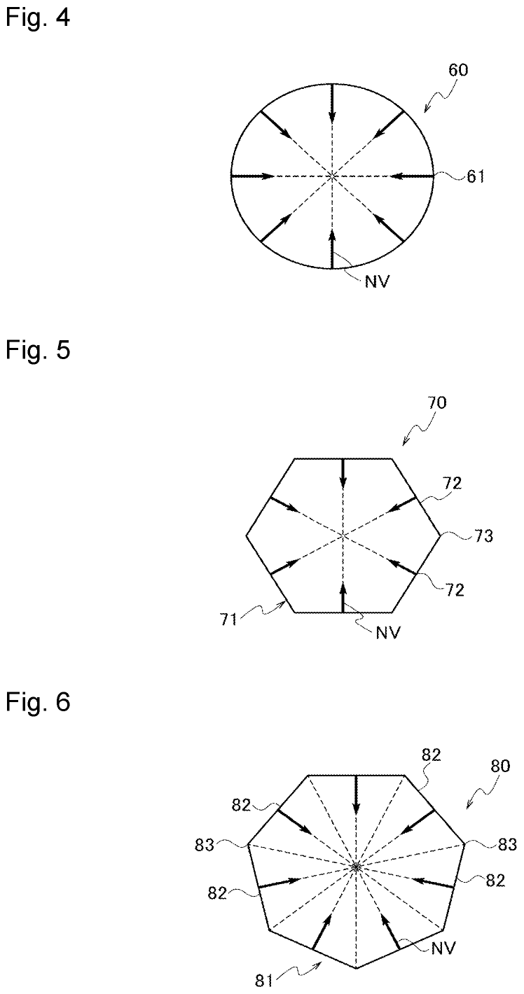

FIG. 4 is a diagram showing a normal vector in a circular core. FIG. 4 shows a circular core 60 in which a core cross section is a circle. An outer edge portion 61 of the circular core 60 has a circumferential shape. A normal vector NV travelling from the outer edge portion 61 toward the inside of the circular core 60 determines a reflection condition of the light beam propagating in the optical fiber. In the case of the circular core 60, the normal vector NV at any point on the outer edge portion 61 is in a reverse direction to the normal vector NV at a point symmetrical with respect to the central axis. In other words, the angle formed by the both normal vectors NV is 180°. When there are the normal vectors NV facing each other, some of the light beams propagating in the process fiber 50 merely reciprocate in a simple manner. As a result, the mode mixing during propagation is not sufficient and thus the intensity distribution of the beam profile is not uniform.

FIG. 5 is a diagram showing a normal vector in a hexagonal core. FIG. 5 shows a hexagonal core 70 in which a core cross section is a regular hexagon as an example of an m-polygonal core in which a core cross section is an m-polygon (m: an even number). An outer edge portion 71 of the hexagonal core 70 is formed of six sides 72, each of which is made of a straight line, and six corner portions 73 respectively connecting the sides 72 adjacent to each other. Also in the hexagonal core 70, the normal vectors NV of the opposing sides 72 face each other. As a result, the mode mixing during propagation is not sufficient and thus the intensity distribution in the beam profile is not uniform.

Note that in addition to the hexagonal core 70 shown in FIG. 5, other m-polygonal cores also include the normal vectors NV facing each other. As a result, the mode mixing during propagation is not sufficient and thus the intensity distribution in the beam profile is not uniform.

FIG. 6 is a diagram showing a normal vector in a heptagonal core. FIG. 6 shows a heptagonal core 80 in which a core cross section is a regular heptagon as an example of an n-polygonal core in which a core cross section is an n-polygon (n: an odd number). An outer edge portion 81 of the heptagonal core 80 is formed of seven sides 82, each of which is made of a straight line, and seven corner portions 83 respectively connecting the sides 82 adjacent to each other. In the case of the heptagonal core 80, there is no normal vector NV that is in a diagonally opposite relationship with the normal vector NV of a certain side 82. When there are no normal vectors NV facing each other, it is possible to suppress the light beam from reciprocating in a simple manner when propagating in the process fiber 50. As a result, the mode mixing during propagation is promoted and the intensity distribution in the beam profile can be made uniform.

Note that in addition to the heptagonal core 80 shown in FIG. 6, other n-polygonal cores also include no normal vectors NV facing each other. As a result, it is considered that the mode mixing during propagation is promoted and the intensity distribution in the beam profile can be made uniform.

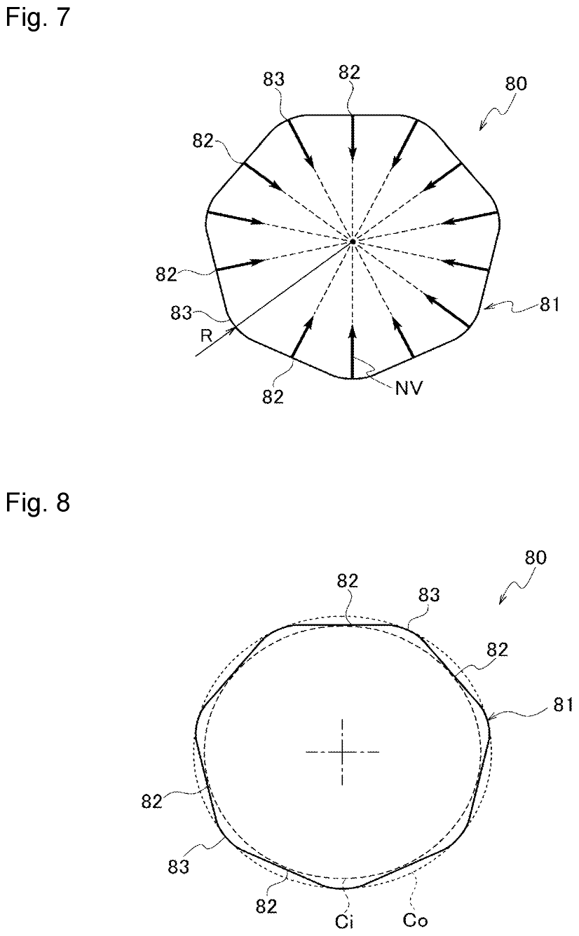

FIG. 7 is a diagram showing a normal vector in a heptagonal core in which the R shape is provided at the corner portion thereof. Now, the shape of the heptagonal core 80 is ideal if the corner portion 83 thereof has a sharp corner shape. However, in the heptagonal core 80 that is actually produced, it is necessary to set the R shape at the corner portion 83 as shown in FIG. 7 in order to suppress cracking and the like of an optical fiber base material and the optical fiber, which is caused by stress concentration. Even so, the normal vector NV of the corner portion 83 at which the R shape is set may be in an opposite relationship with the normal vector NV of the side 82 opposed to the corner portion 83. As a result, depending on the range of the R shape set at the corner portion 83, the proportion of the light beams that reciprocate in a simple manner may increase when the light beams propagate in the process fiber 50, which may result in insufficient mode mixing during the propagation.

FIG. 8 is a diagram showing the relationship between the outer edge portion of the heptagonal core, and a circumscribed circle circumscribed to the outer edge portion and an inscribed circle inscribed to the outer edge portion. The optimum range of the R shape that can promote the mode mixing during propagation will be considered. As shown in FIG. 8, a circumscribed circle Co circumscribed to the outer edge portion 81 of the heptagonal core 80 is considered, and the R shape of each of the corner portions 83 is defined along the circumscribed circle Co. The larger the diameter of the circumscribed circle Co is, the larger the range of the side 82 is and the smaller the range of the corner portion 83 (the R shape) is.

In order to relatively evaluate a plurality of the circumscribed circles Co having various diameters, an inscribed circle Ci inscribed to the outer edge portion 81 is considered. The inscribed circle Ci is inscribed to the respective sides 82 that constitute the outer edge portion 81. The optimum solution of the R shape of the corner portion 83 is considered on the basis of the value obtained by dividing the diameter of the circumscribed circle Co by the diameter of the inscribed circle Ci, that is, the diameter ratio between the circumscribed circle Co and the inscribed circle Ci.

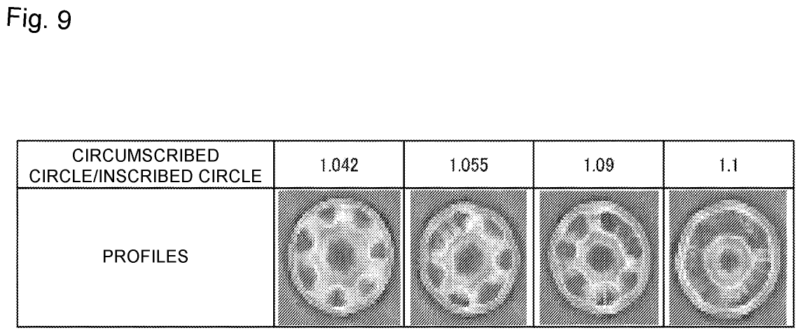

FIG. 9 is a diagram showing the beam profile with respect to the ratio between the circumscribed circle and the inscribed circle. The beam profiles are measured while changing the diameter ratio between the circumscribed circle Co and the inscribed circle Ci. The measured beam profiles correspond to those of the ring type. FIG. 9 shows the measurement results of four types of beam profiles having the diameter ratios between the circumscribed circle Co and the inscribed circle Ci of 1.042, 1.055, 1.09, and 1.1, respectively. As can be seen from FIG. 9, when the diameter ratio between the circumscribed circle Co and the inscribed circle Ci is increased, that is, when the range of the R shape is decreased, there is a tendency that the intensity distribution of the beam profile is less uneven and the mode mixing is promoted. When the diameter ratio between the circumscribed circle Co and the inscribed circle Ci is 1.09 or more, it is considered that the intensity distribution of the beam profile is even and thus the mode mixing during propagation can be promoted.

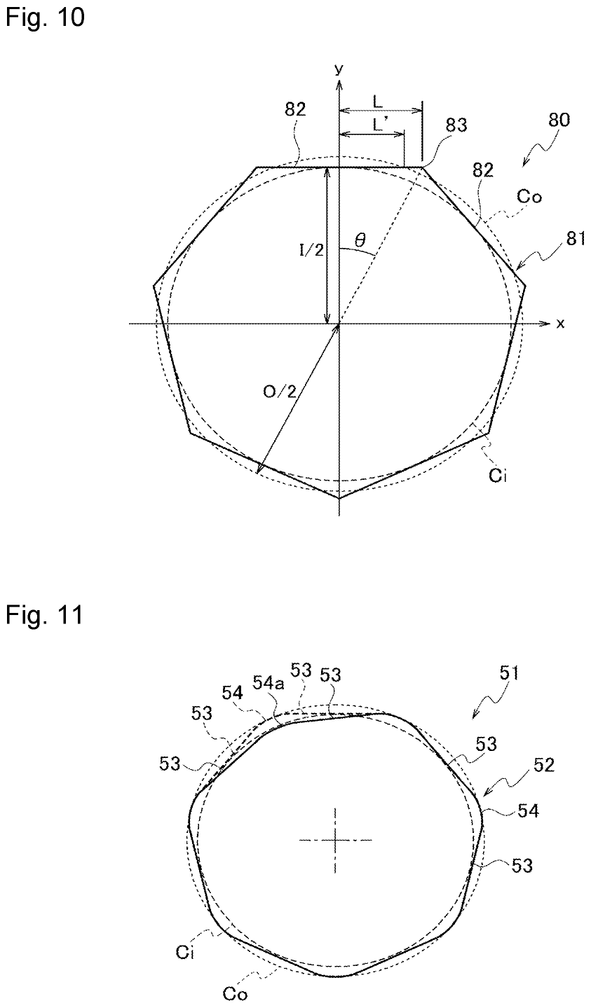

FIG. 10 is a diagram illustrating a parameter for defining the R shape of the corner portion. As shown in FIG. 10, the core cross section of the heptagonal core 80 is defined in a two-dimensional Cartesian coordinate system with an x-axis and a y-axis. The center of gravity of the core cross section corresponds to the origin position of the coordinate system, and the core cross section is defined such that one side 82 of the seven sides 82 is orthogonal to the y-axis. The diameter of the inscribed circle Ci inscribed to the respective sides 82 of the core cross section (the outer edge portion 81) is “I”, and the diameter of the circumscribed circle Co defining the R shape of the corner portion 83 is “O”. Further, the distance between the corner portion 83, which is located at the end portion of the side 82 orthogonal to the y-axis, and the y-axis is “L”, the distance between the intersection of the side 82 orthogonal to the y-axis and the circumscribed circle Co and the y-axis is “L′”.

When the number of the corner portions 83 is set to be n so as to be generalized into the n-polygonal core, an angle θ formed by the corner portion 83, which is located at the end portion of the side 82 orthogonal to the y-axis, and the y-axis is expressed by the following mathematical formula 1.

$$θ = \frac{π}{n} \qquad [ Formula 1 ]$$

The distance L is expressed by the following mathematical formula 2.

$$L = \frac{I}{2} tan θ \qquad [ Formula 2 ]$$

The side 82 orthogonal to the y-axis is expressed by the following mathematical formula 3.

$$y = \frac{I}{2} \qquad [ Formula 3 ]$$

The equation of the circumscribed circle Co is expressed by the following mathematical formula 4.

$${x}^{2} + {y}^{2} = {( \frac{O}{2} )}^{2} \qquad [ Formula 4 ]$$

When the mathematical formula 4 is used, the intersection of the side 82 orthogonal to the y-axis and the circumscribed circle Co is expressed by the following mathematical formula 5.

$${( {L}^{′} )}^{2} + {( \frac{I}{2} )}^{2} = {( \frac{O}{2} )}^{2} \qquad [ Formula 5 ]$$

From the mathematical formula 5, the distance L′ is expressed by the following mathematical Formula 6.

$${L}^{′} = \frac{\sqrt{{O}^{2} - {I}^{2}}}{2} \qquad [ Formula 6 ]$$

Here, the measurement results shown in FIG. 9 is data on the heptagonal core 80, but the tendency of the beam profiles is the same for the other n-polygonal cores. Therefore, in the n-polygonal core, the diameter ratio between the circumscribed circle Co and the inscribed circle Ci that sufficiently promotes the mode mixing is set to be 1.09 or more. For example, a diameter O of the circumscribed circle Co is set to be 1.09, and a diameter I of the inscribed circle Ci is set to be 1. In this case, the distance L′ is 0.21685 from the mathematical formula 6. At this time, the distance L is 0.2407 from the mathematical formula 2. From this, the relation of the following mathematical formula 7 is satisfied between the distance L and the distance L′.

L′=0.9L [Formula 7]

In other words, in the n-polygonal core, if the length (the distance L′) of the side 82 that is a straight line is 90% or more of the distance L, the mode mixing is promoted.

From the mathematical formulas 3, 5 and 7, the relation of the following mathematical formula 8 is satisfied.

$${( \frac{9 I}{20} tan ( θ ) )}^{2} + {( \frac{I}{2} )}^{2} = {( \frac{O}{2} )}^{2} \qquad [ Formula 8 ]$$

When the mathematical formula 8 is arranged by using the mathematical formula 1, the diameter ratio between the circumscribed circle Co and the inscribed circle Ci is expressed by the following mathematical formula 9.

$$\frac{O}{I} = \sqrt{1 + 0.81 {tan}^{2} ( \frac{π}{n} )} \qquad [ Formula 9 ]$$

The mathematical formula is further arranged in the similar manner. When the distance L and the distance L′ are equal, the diameter ratio between the circumscribed circle Co and the inscribed circle Ci is expressed by the following mathematical formula 10.

$$\frac{O}{I} = \sqrt{1 + {tan}^{2} ( \frac{π}{n} )} \qquad [ Formula 10 ]$$

From the mathematical formulas 9 and 10, in the n-polygonal core, when the optimum range of the R shape in which the mode mixing works effectively is defined by a diameter ratio α between the circumscribed circle Co and the inscribed circle Ci, the following equation 11 is obtained. Here, the diameter ratio α between the circumscribed circle Co and the inscribed circle Ci is a value (O/I) obtained by dividing the diameter O of the circumscribed circle Co by the diameter I of the inscribed circle Ci.

$$\sqrt{1 + 0.81 {tan}^{2} ( \frac{π}{n} )} \leq α \leq \sqrt{1 + {tan}^{2} ( \frac{π}{n} )} \qquad [ Formula 11 ]$$

According to the core 51 of the process fiber 50 according to the present embodiment shown in FIGS. 2 and 3, as shown in the concept described above, the R shape is set at each of the corner portions 54 in accordance with the diameter ratio α of the range shown by the mathematical formula 11. In other words, the outer edge portion 52 of the core cross section includes the seven sides 53 and the seven corner portions 54 respectively connecting the sides adjacent to each other so that these sides 53 are continuous. Then, each of the seven corner portions 54 has the R shape along the circumscribed circle circumscribed to the outer edge portion 52. In this case, when the diameter of the inscribed circle inscribed to the outer edge portion 52 is I and the number of the seven corner portions 54 is n, the diameter ratio α, which is the ratio between the diameter of the circumscribed circle and the diameter of the inscribed circle, satisfies the relation of the mathematical formula 11.

According to this configuration, by forming the core cross section to be heptagonal, it is possible to suppress the light beam during propagation from reciprocating in a simple manner. In addition, by providing the limitation shown in the mathematical formula 11 to the R shape of the corner portion 54, it is possible to reduce the proportion of the light beams that reciprocate in a simple manner due to the R shape of the corner portion 54. As a result, the mode mixing during propagation can be promoted and the intensity distribution in the beam profile can be made uniform.

It should be noted that in the embodiment described above, the heptagonal core in which the core cross section is a regular heptagon has been described as the core 51 that constitutes the process fiber 50. However, the shape of the core cross section of the core 51 may be an n-polygon other than the heptagon.

FIG. 11 is a diagram showing a modified example of the heptagonal core. In the present embodiment, the core cross section of the core 51 is a regular heptagon. However, as shown in FIG. 11, the core 51 may be a heptagonal core including a corner portion 54a having an angle that is different from that of the corner portion 54 along the regular heptagon. In this case, the number of the corner portions 54a having different angles may be one or more. In the core 51 described above, it is sufficient that the R shape satisfies the relation of the mathematical formula 11 in at least one corner portion 54 that corresponds to the shape of the regular heptagon.

### Second Embodiment

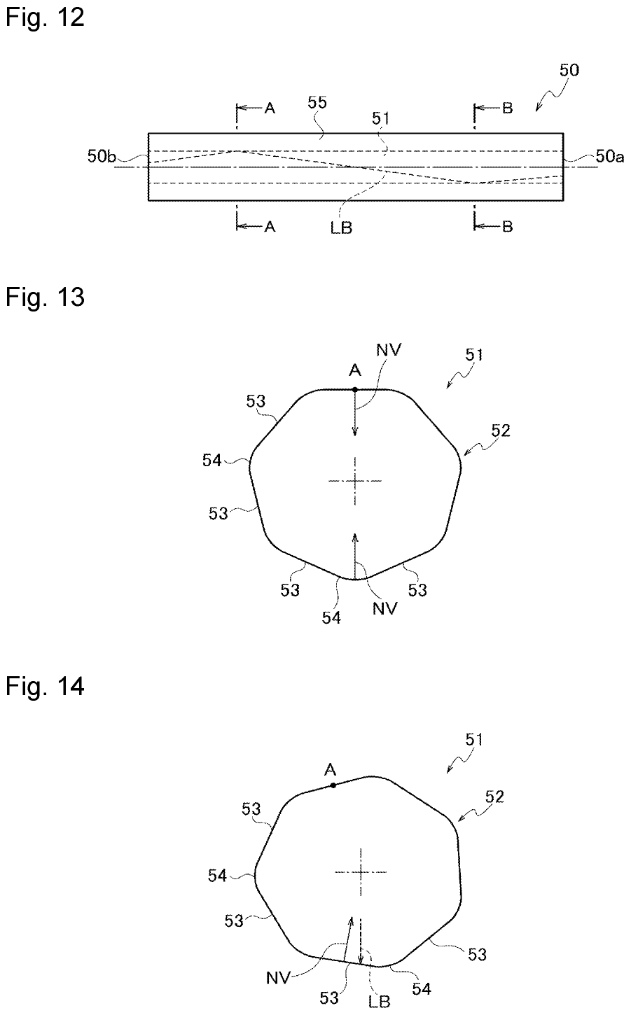

Hereinafter, a process fiber 50 according to a second embodiment will be described. The description that overlaps with that of the first embodiment will be omitted, and the differences will be mainly described below. FIG. 12 is a diagram illustrating a configuration of an optical fiber according to the second embodiment. FIG. 13 is a diagram illustrating an AA cross section of a heptagonal core shown in FIG. 12. FIG. 14 is a diagram illustrating a BB cross section of the heptagonal core shown in FIG. 12.

As shown in FIGS. 12 to 14, a core 51 of the process fiber 50 according to the present embodiment has a twisted shape twisted around the central axis in the direction of the central axis of the core 51. The outer edge portion 52 (see FIG. 13) of the core cross section in the BB cross section shown in FIG. 12 is in a relationship rotated by a predetermined amount in the circumferential direction with respect to the outer edge portion 52 (see FIG. 14) of the core cross section in the AA cross section shown in FIG. 12.

Here, a light beam LB that is reflected along the normal vector NV at a point A on a certain side 53 in the AA cross section is considered. In the AA cross section, the normal vector NV at the point A is in a relationship opposed to the normal vector NV at the diagonal corner portion 54. On the other hand, as shown in FIG. 12, since the light beam LB is propagated along the axial direction, the light beam LB reflected at the point A is reflected at the outer edge portion 52 in the BB cross section. At this time, the light beam LB is made incident at a position deviated from the corner portion 54 due to the influence of the twisting of the core 51. For this reason, in the case of the core 51 having a twisted shape, it is possible to reduce the proportion of the light beams that reciprocate in a simple manner when the light beams LB propagate through the process fiber 50. Therefore, in the core 51 having a twisted shape, even if the setting range of the R shape of the corner portion 54 is made larger than that of the core 51 having no twisted shape, it is possible to obtain the effect of the mode mixing that is equivalent to that of the core 51 having no twisted shape.

When the core 51 has a twisted shape as described above, the diameter ratio α between the circumscribed circle Co and the inscribed circle Ci satisfies the following mathematical formula 12. Here, a constant k is a positive number smaller than 1.

$$k \cdot \sqrt{1 + 0.81 {tan}^{2} ( \frac{π}{n} )} \leq α \leq \sqrt{1 + {tan}^{2} ( \frac{π}{n} )} \qquad [ Formula 12 ]$$

According to this configuration, by forming the core cross section to be n-polygonal, it is possible to suppress the light beam during propagation from reciprocating in a simple manner. In addition, by providing the limitation shown in the mathematical formula 11 to the R shape of the corner portion 54 in accordance with the twisted shape, it is possible to reduce the proportion of the light beams that reciprocate in a simple manner due to the R shape of the corner portion 54. As a result, the mode mixing during propagation is promoted and the intensity distribution in the beam profile can be made uniform.

It should be noted that in the embodiment described above, the heptagonal core in which the core cross section is a regular heptagon has been described as the core 51 that constitutes the process fiber 50. However, the shape of the core cross section may be an n-polygon other than the heptagon.

Further, in each of the embodiments described above, a single clad fiber is exemplified as the process fiber 50. However, the process fiber 50 may be a multi-clad fiber.

The present invention is not limited to each of the embodiments described above, and various modifications can be made without departing from the summary of the present invention.

The disclosure of the present application is related to the subject matter described in Japanese Patent Application No. 2020-030597 filed on Feb. 26, 2020, all of which are incorporated herein by reference.

1. An optical fiber including a core extending along a central axis and a clad covering a circumference of the core, the optical fiber comprising:
an outer edge portion constituting an outer edge of a core cross section obtained by vertically cutting the core with respect to the central axis of the core, wherein
the outer edge portion includes:
a plurality of sides; and
a plurality of corner portions respectively connecting the sides adjacent to each other so that the plurality of sides are continuous;
at least one corner portion of the plurality of corner portions has an R shape along a circumscribed circle circumscribed to the outer edge portion; and
when a diameter of the circumscribed circle is O, a diameter of an inscribed circle inscribed to the outer edge portion is I, and the number of the plurality of corner portions is n (n=an odd number), a diameter ratio α (α=O/I), which is a ratio between the diameter O of the circumscribed circle and the diameter I of the inscribed circle, satisfies a following mathematical formula.
$$\sqrt{1 + 0.81 {tan}^{2} ( \frac{π}{n} )} \leq α \leq \sqrt{1 + {tan}^{2} ( \frac{π}{n} )} \qquad [ Formula 1 ]$$

2. The optical fiber according to claim 1, wherein the core cross section is an n-polygon in which lengths of the respective sides are equal and angles of the respective corner portions are equal.

3. The optical fiber according to claim 1, wherein when the core has a twisted shape twisted around the central axis in an axis direction of the central axis of the core and a constant k is a positive number smaller than 1, the diameter ratio α satisfies a following mathematical formula.
$$k \cdot \sqrt{1 + 0.81 {tan}^{2} ( \frac{π}{n} )} \leq α \leq \sqrt{1 + {tan}^{2} ( \frac{π}{n} )} \qquad [ Formula 2 ]$$

4. A laser processing machine, comprising:
a laser oscillator configured to output a laser beam;
a main body of the laser processing machine configured to perform laser processing by using the laser beam output from the laser oscillator; and
an optical fiber configured to transmit the laser beam emitted from the laser oscillator to the main body of the laser processing machine, the optical fiber including a core extending along a central axis and a clad covering a circumference of the core, wherein
the optical fiber includes an outer edge portion constituting an outer edge of a core cross section obtained by vertically cutting the core with respect to the central axis of the core,
the outer edge portion includes:
a plurality of sides; and
a plurality of corner portions respectively connecting the sides adjacent to each other so that the plurality of sides are continuous,
at least one corner portion of the plurality of corner portions has an R shape along a circumscribed circle circumscribed to the outer edge portion, and
when a diameter of the circumscribed circle is O, a diameter of an inscribed circle inscribed to the outer edge portion is I, and the number of the plurality of corner portions is n (n=an odd number), a diameter ratio α (α=O/I), which is a ratio between the diameter O of the circumscribed circle and the diameter I of the inscribed circle, satisfies a following mathematical formula.
$$\sqrt{1 + 0.81 {tan}^{2} ( \frac{π}{n} )} \leq α \leq \sqrt{1 + {tan}^{2} ( \frac{π}{n} )} \qquad [ Formula 3 ]$$

5. The laser processing machine according to claim 4, wherein the core cross section is an n-polygon in which lengths of the respective sides are equal and angles of the respective corner portions are equal.

6. The laser processing machine according to claim 4, wherein when the core has a twisted shape twisted around the central axis in an axis direction of the central axis of the core and a constant k is a positive number smaller than 1, the diameter ratio α satisfies a following mathematical formula.
$$k \cdot \sqrt{1 + 0.81 {tan}^{2} ( \frac{π}{n} )} \leq α \leq \sqrt{1 + {tan}^{2} ( \frac{π}{n} )} \qquad [ Formula 4 ]$$
